(19) United States
(12) Patent Application Publication
(10) Pub. No.: US 2014/0177271 A1
(43) Pub. Date: Jun. 26, 2014

(54) LED BACKLIGHT MODULE HAVING REDUCED LIGHT LEAKAGE, INCREASED LIGHT EXTRACTION EFFICIENCY AND REDUCED COST

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 13/875,297

(22) Filed: May 2, 2013

(30) Foreign Application Priority Data
Dec. 21, 2012 (TW) 101148894

(51) Int. Cl. F21V 8/00

(52) U.S. Cl. CPC G02B 6/0016
USPC 362/608

(57) ABSTRACT

A backlight module includes a light guiding board and a plurality of LED light sources located at a flat lateral side of the light guiding board. The light guiding board comprises a first portion and a second portion, and the first portion is located between the LED light sources and the second portion. The first portion is intimately matched and engaged with the second portion. The refractive index of the first portion is unequal to that of the second portion. A plurality of micro-structures are formed on the surface of the first portion facing towards the second portion. The micro-structure is used for diffusing the light of the LED light sources when the light travels from the first portion to the second portion. The second portion is quite larger than the first portion.

### BACKGROUND

1. Technical Field

The present disclosure relates to an LED (light emitting diode) backlight module, and more particularly to an LED backlight module for an LCD (light crystal display) panel, where the LED backlight module can have decreased light leakage, increased light extraction efficiency and reduced cost.

2. Description of Related Art

LEDs (light emitting diode) have been widely promoted as light sources of electronic devices owing to many advantages, such as high luminosity, low operational voltage and low power consumption. An LED backlight module of an LCD (liquid crystal display) panel includes a light guiding board and a plurality of LED light sources located at one edge side of the light guiding board. If the edge side of the light guiding board forms a rugged micro-structure, the entrance angle of the light generated by the LED light sources into the light guiding board is larger, and the light emitted from the LED light sources is more uniformly distributed in the light guiding board. An air gap is defined between the LED light sources and the rugged edge side of the light guiding board, so a part of the light emitted by the LED light sources will be unavoidably lost in the air gap, whereby a light leakage is formed and the utilization rate of the light of the LED light sources is decreased. If the edge side of the light guiding board is a flat surface, the LED light sources are firmly attached to the edge side of the light guiding board. Although such arrangement can increase the optical coupling between the LED light sources and the light guiding board to increase the extraction efficiency of the light generated by the LED light sources into the light guiding board, the entrance angle of the light of the LED light sources into the light guiding board is decreased, and accordingly the light emitted from the LED light sources is less uniformly distributed in the light guiding board, whereby more LED light sources are required. The increased number of the LED light sources increases the cost of the LED backlight module.

Therefore, an LED backlight module capable of overcoming the above described shortcomings is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a top view of a backlight module in accordance with a first embodiment of the present disclosure.

FIG. 2 shows a top view of a backlight module in accordance with a second embodiment of the present disclosure.

FIG. 3 shows a top view of a backlight module in accordance with a third embodiment of the present disclosure.

FIG. 4 shows a top view of a backlight module in accordance with a fourth embodiment of the present disclosure.

### DETAILED DESCRIPTION

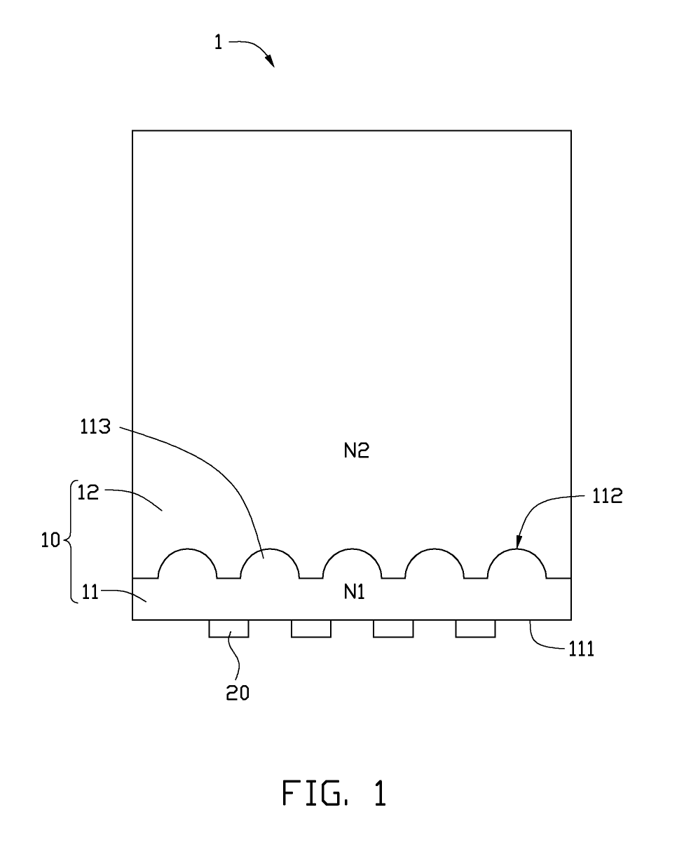

Referring to FIG. 1, a backlight module 1 in accordance with a first embodiment of the present disclosure includes a light guiding board 10 and a plurality of LED light sources 20 located at a lateral edge side of the light guiding board 10. The LED light sources 20 are attached to the lateral edge side of the light guiding board 10. The backlight module 1 is an edge-type LED backlight module.

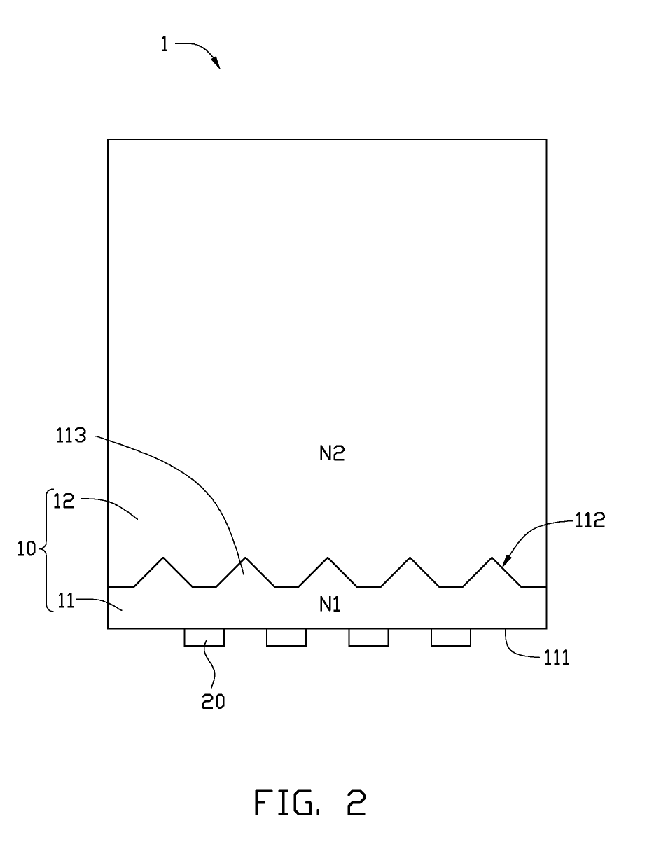

The light guiding board 10 is a thin and flat board. The light guiding board 10 includes a first portion 11 and a second portion 12; the first portion 11 is located between the LED light sources 20 and the second portion 12. The second portion 12 has an area quite larger than an area of the first portion 11. Preferably, the first portion 11 occupies less than 3% of the total area of the light guiding board 10. The first portion 11 is intimately matched and engaged with the second portion 12. N₁ is the refractive index of the first portion 11 of the light guiding board 10, N₂ is the refractive index of the second portion 12 of the light guiding board 10, and N₁ is unequal to N₂. The first portion 11 includes a lateral surface 111 apart from the second portion 12, and the LED light sources 20 are attached to the lateral surface 111 of the first portion 11 and arranged along a horizontal direction. The lateral surface 111 is a flat surface. A plurality of micro-structures 112 are formed on the surface of the first portion 11 facing towards the second portion 12. The micro-structures 112 are used for diffusing the light of the LED light sources 20 traveling from the first portion 11 to the second portion 12. In this embodiment, the micro-structures 112 are a plurality of protrusions 113 extruding toward the second portion 12, and N₁<N₂. Further, a cross-section of each of the protrusions 113 is semicircular. Referring to FIG. 2, the cross-section of each of the protrusions 113 can be triangular.

In use of the backlight module 1, light emitted from the LED light sources 20 is transmitted into the first portion 11 of the light guiding board 10, and is refracted at the interface of the first portion 11, where the micro-structures 112 are formed. For N₁<N₂, according to the theory of refraction of light, the light refracted at the micro-structures 112 is more scattered, and the light emitted from the LED light sources 20 and into the second portion 12 is more uniformly mixed together.

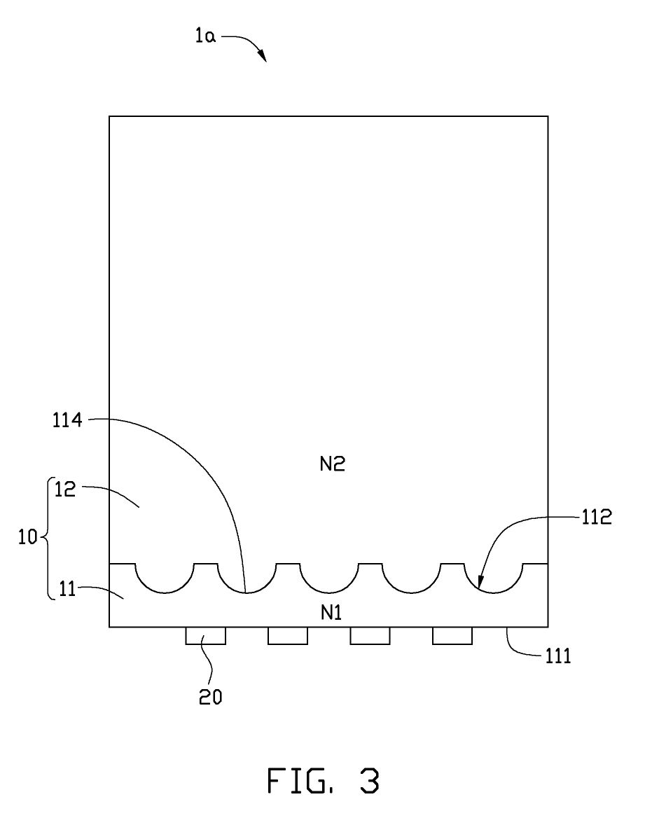

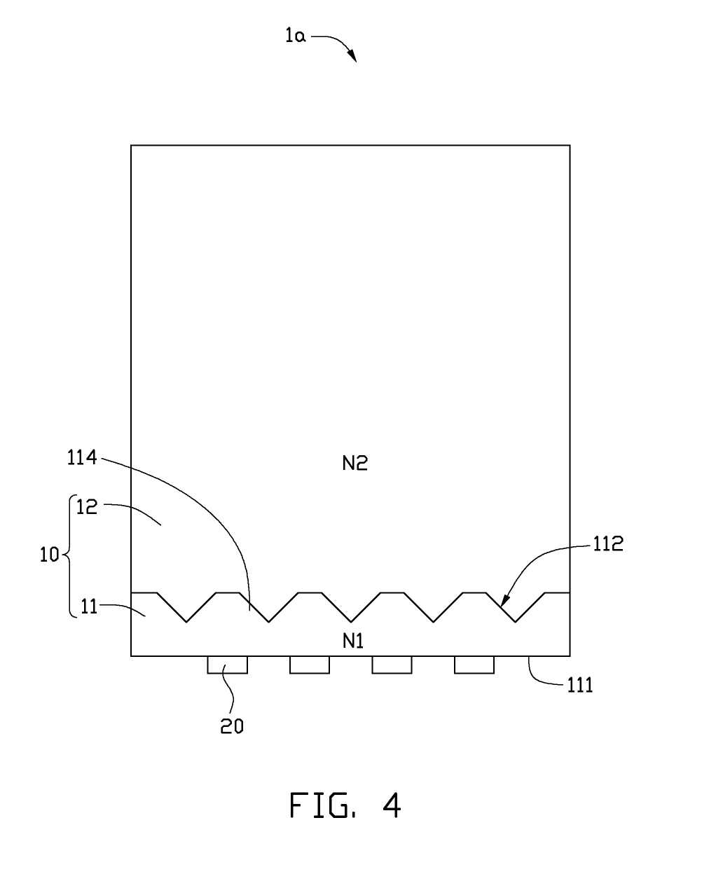

Referring to FIG. 3, the backlight module la of a third embodiment of the present disclosures is similar to the backlight module 1, and the difference between the backlight module 1a and the backlight module 1 is: the micro-structures 112 are a plurality of concavities 114 depressed towards the lateral surface 111, and N₁>N₂. Further, the cross-section of each of the concavities 114 is semicircular. Referring to FIG. 4, the cross-section of each of the concavities 114 can be triangular.

In the present disclosure, the LED light sources 20 are attached to a flat surface of the light guiding board 10, whereby light leakage of the LED light sources 20 can be eliminated; thus, the utilization efficiency of the light generated by the LED light sources 20 can be increased whereby the required number of the LED light sources 20 can be decreased to reduce the cost of the LED backlight module 1 (1a). Furthermore, by the provision of the micro-structures 112 between the first and second portions 11, 12 of the light guiding board 10, the light from the LED sources 20 can be uniformly mixed in the second portion 12 of the light guiding board 10, whereby the backlight module 1 (1a) can uniformly illuminate an LCD panel.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An edge-type backlight module, comprising:
a light guiding board; and
a plurality of LED light sources attached to a flat lateral side of the light guiding board;
wherein the light guiding board comprises a first portion and a second portion, the first portion is located between the LED light sources and the second portion, and the first portion is intimately matched and engaged with the second portion, a refractive index of the first portion is unequal to that of the second portion, a plurality of micro-structures is formed on a surface of the first portion facing towards the second portion, the micro-structures are used for diffusing light generated by the LED light sources and traveling from the first portion to the second portion.

2. The edge-type backlight module of claim 1, wherein the refractive index of the first portion is less than that of the second portion.

3. The edge-type backlight module of claim 2, wherein the micro-structures are a plurality of protrusions extruding toward the second portion.

4. The edge-type backlight module of claim 3, wherein a cross-section of each of the protrusions is semicircular.

5. The edge-type backlight module of claim 3, wherein a cross-section of each of the protrusions is triangular.

6. The edge-type backlight module of claim 3, wherein two adjacent ones of the protrusions are spaced a distance from each other.

7. The edge-type backlight module of claim 1, wherein the refractive index of the first portion is greater than that of the second portion.

8. The edge-type backlight module of claim 7, wherein the micro-structures are a plurality of concavities depressed toward the LED light sources.

9. The edge-type backlight module of claim 8, wherein a cross-section of each of the concavities is semicircular.

10. The edge-type backlight module of claim 8, wherein a cross-section of each of the concavities is triangular.

11. The edge-type backlight module of claim 1, wherein an area of the first portion is quite smaller than an area of the second portion.

12. The edge-type backlight module of claim 11, wherein the area of the first portion is less than 3% of a total area of the light guiding board.
